(19) United States
(12) Patent Application Publication
(10) Pub. No.: US 2005/0044954 A1
(43) Pub. Date: Mar. 3, 2005

(54) Method and apparatus for determining absolute angular velocity

(75) Inventor: Angelo Truncale, Lake Forest, CA (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(73) Assignee: The Boeing Company

(21) Appl. No.: 10/648,003

(22) Filed: Aug. 26, 2003

(51) Int. Cl. G01P 15/14

(52) U.S. Cl. 73/504.18

(57) ABSTRACT

A method and apparatus for determining an absolute angular velocity of a vehicle that rotates during operation about an axis of rotation. The vehicle includes a vehicle body and a gyroscope rotatably mounted on the body for rotation with respect to the body about a gyroscope axis generally aligned with the axis of rotation. The gyroscope is rotated with respect to the vehicle body about the gyroscope axis in a direction opposite to rotation of the vehicle so an absolute angular velocity of the gyroscope about the gyroscope axis tends to remain about zero. A rotational speed of the gyroscope is measured about the gyroscope axis with respect to the vehicle body. The rotational speed of the gyroscope corresponds to the absolute angular velocity of the vehicle about the axis of rotation.

### BACKGROUND OF THE INVENTION

The present invention relates generally to determining absolute angular velocity of a vehicle, and more specifically to determining an absolute angular velocity of a spin-stabilized vehicle.

In some applications, vehicle guidance and navigation systems may require that rotation of a vehicle about an axis of rotation be controlled to stabilize the vehicle as it follows its trajectory or flight path. Specifically, to maintain specific roll, pitch, and azimuth angles of the vehicle, such as a missile, as it travels along its trajectory or flight path, the vehicle may be required to rotate at a particular speed. For vehicles with high rotational speeds, a very accurate roll gyroscope scale factor may be required to accurately measure the rotational speed of the vehicle. However, typical gyros that are commercially available may not possess such accuracy. Additionally, as the vehicle is stored gyro scale factors (i.e., calibration factors) may change depending on the length of time and the temperature at which the vehicle is stored. Accordingly, knowledge of the current scale factor of a gyroscope may be necessary to accurately measure the rotational speed of a vehicle. Unfortunately, measuring scale factors can be difficult and expensive, and measuring must be done continuously over the length of time the vehicle is stored to ensure accurate measurement of a rotational speed of the vehicle when operation of the vehicle is desired. Current methods of mitigating scale factor errors focus on inertially stabilizing the entire guidance and navigation system using gimbals. However, such methods are typically expensive and complex.

### SUMMARY OF THE INVENTION

In one aspect, the present invention includes apparatus for determining an absolute angular velocity of a vehicle that rotates during operation about an axis of rotation. The apparatus includes a motor having a stator mountable on the vehicle for movement with the vehicle and a rotor rotatably mounted on the stator for rotation about a rotor axis generally aligned with the axis of rotation of the vehicle, and a gyroscope coupled to the motor rotor for rotation with respect to the stator about the rotor axis. The gyroscope has an input axis generally aligned with the rotor axis, and the gyroscope is configured to produce a gyroscope output signal representing an absolute angular velocity at which the gyroscope travels about the input axis. The apparatus also includes a motor control operatively connected to the motor for controlling a speed of rotation of the rotor, wherein the control is configured to rotate the gyroscope about the input axis in a direction opposite to the angular velocity of the vehicle so the gyroscope output signal tends to remain about zero. Additionally, the apparatus includes a resolver having a stationary member mountable on the vehicle for movement with the vehicle and a rotating member coupled to the motor rotor for rotation with the motor rotor about the rotor axis, wherein the resolver is configured to produce a resolver output signal representing a rotational speed of the rotating member about the rotor axis that corresponds to the speed of rotation of the motor rotor and likewise corresponds to the absolute angular velocity of the vehicle about the axis of rotation.

In another aspect, the present invention includes a vehicle that rotates during operation about an axis of rotation. The vehicle includes a body, a control system mounted on the body for controlling motion of the vehicle during operation of the vehicle, and apparatus operatively connected to the control system for determining an absolute angular velocity of the vehicle during operation of the vehicle. The apparatus includes a motor having a stator mounted on the vehicle for movement with the vehicle and a rotor rotatably mounted on the stator for rotation about a rotor axis generally aligned with the axis of rotation of the vehicle, and a gyroscope coupled to the motor rotor for rotation with respect to the stator about the rotor axis. The gyroscope has an input axis generally aligned with the rotor axis, and the gyroscope is configured to produce a gyroscope output signal representing an absolute angular velocity at which the gyroscope travels about the input axis. The apparatus also includes a motor control operatively connected to the motor for controlling a speed of rotation of the rotor, wherein the motor control is configured to rotate the gyroscope about the input axis in a direction opposite to the angular velocity of the vehicle so the gyroscope output signal tends to remain about zero. Additionally, the apparatus includes a resolver having a stationary member mounted on the vehicle for movement with the vehicle and a rotating member coupled to the motor rotor for rotation with the motor rotor about the rotor axis, wherein the resolver is configured to transmit to the control system a resolver output signal representing a rotational speed of the rotating member about the rotor axis that corresponds to the speed of rotation of the motor rotor and likewise corresponds to the absolute angular velocity of the vehicle about the axis of rotation. The control system is configured to use the resolver output signal to control the absolute angular velocity of the vehicle to thereby spin-stabilize the vehicle.

In yet another aspect, a method is provided for determining an absolute angular velocity of a vehicle that rotates during operation about an axis of rotation. The vehicle includes a vehicle body and a gyroscope rotatably mounted on the body for rotation with respect to the body about a gyroscope axis generally aligned with the axis of rotation. The method includes the steps of rotating the gyroscope with respect to the vehicle body about the gyroscope axis in a direction opposite to rotation of the vehicle so an absolute angular velocity of the gyroscope about the gyroscope axis tends to remain about zero, and measuring a rotational speed of the gyroscope about the gyroscope axis with respect to the vehicle body, wherein the rotational speed corresponds to the absolute angular velocity of the vehicle about the axis of rotation.

Other features of the present invention will be in part apparent and in part pointed out hereinafter.

### BRIEF DESCRIPTION OF THE DRAWINGS

FIG. 1 is a side elevation of a conventional missile;

FIG. 2 is a perspective of apparatus for determining an absolute angular velocity;

FIG. 3 is a schematic cross section of the apparatus;

FIG. 4 is a separated perspective of the apparatus; and

FIG. 5 is a side elevation of a conventional satellite.

Corresponding reference characters indicate corresponding parts throughout the several views of the drawings.

### DETAILED DESCRIPTION OF THE PREFERRED EMBODIMENT

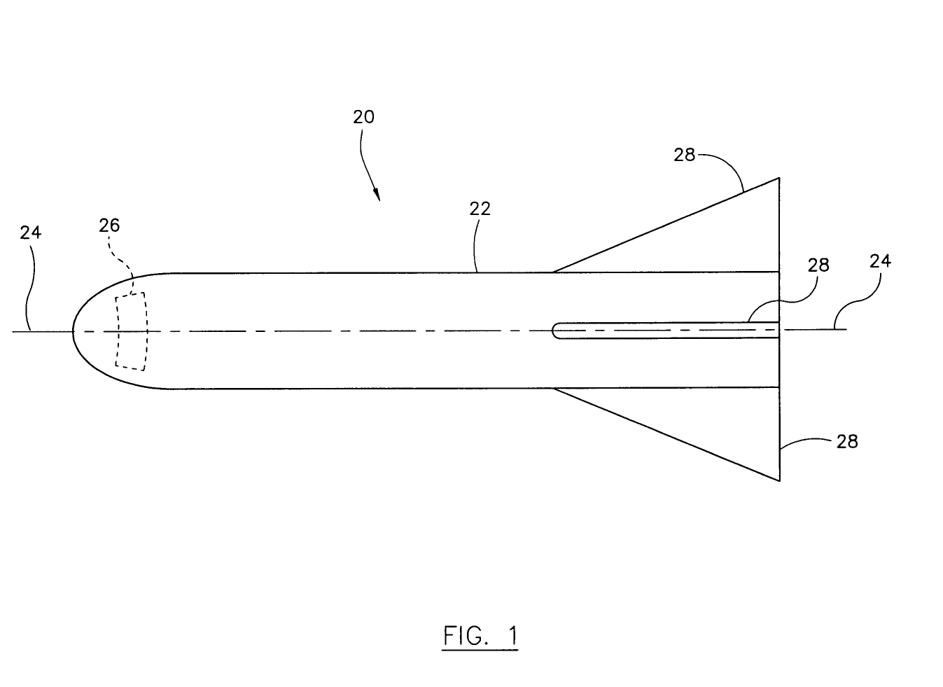

Referring now to the drawings, and more specifically to FIG. 1, a conventional missile, generally designated by the reference numeral 20, includes a generally cylindrical body 22 having an interior cavity (not shown) located therein. The body 22 rotates about an axis of rotation 24 during operation of the missile 20, and more specifically as the missile 20 travels along a trajectory or flight path. A conventional control system 26 is mounted on the body 22 within the interior cavity for controlling motion of the missile 20 using a plurality of airfoils 28 rotatably mounted on the body 22. Specifically, the control system 26 controls roll, pitch, and azimuth angles of the body 22 as the missile 20 travels along its trajectory or flight path to accurately guide the missile 20 to its target. The control system 26 also controls rotation of the body 22 about the axis of rotation 24 to stabilize, commonly referred to as spin-stabilize, the missile body 22 during flight. It should be understood that the missile 20 may be any suitable projectile, such as a missile fired from a weapon (not shown) or a self-propelled rocket. Alternatively, the missile 20 may be dropped from a vehicle in flight and drawn to its target by gravity. Furthermore, the missile 20 may be used for air to surface, surface to air, and/or surface to surface applications. Because most of the features of the missile 20 are conventional, general features of the missile 20 will not be described in further detail.

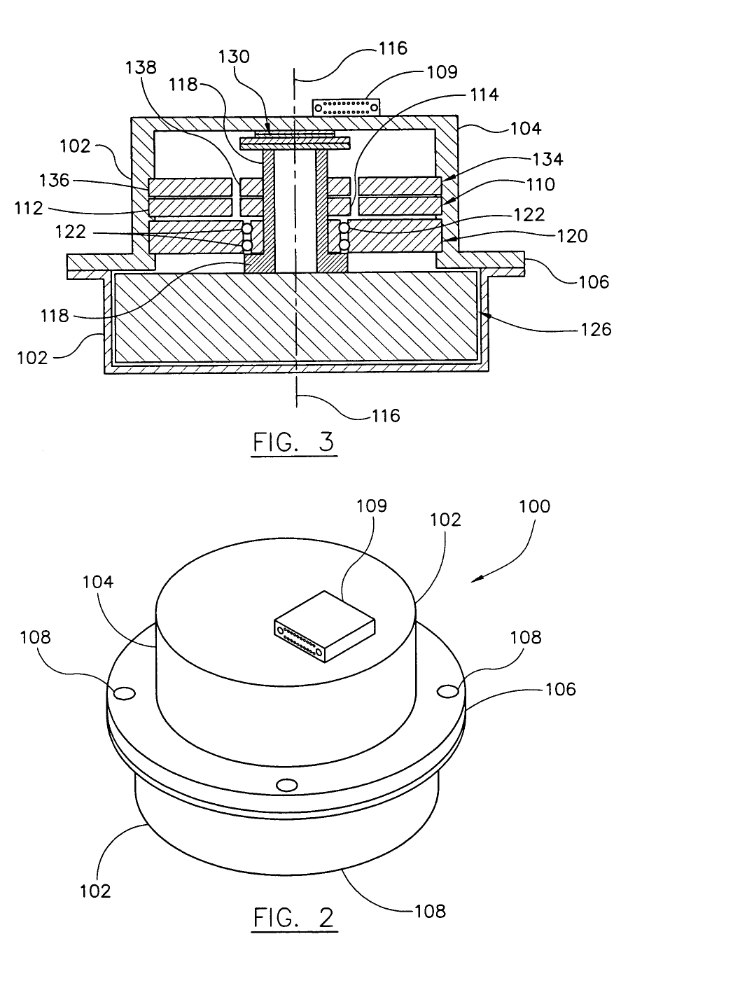

Referring to FIG. 2, apparatus for determining an absolute angular velocity of the missile 20 (FIG. 1) is designated in its entirety by the reference numeral 100. The apparatus 100 is mounted on the body 22 (e.g., within the interior cavity) for determining an absolute angular velocity of the missile 20 (FIG. 1), and more specifically the missile body 22 (FIG. 1) as the body rotates about the axis of rotation 24 (FIG. 1). The apparatus 100 includes a mount 102 mountable on the missile body 22 for movement with the body. In the exemplary embodiment, the mount 102 includes a generally cylindrical housing having an outer surface 104. A flange 106 extending radially outward from the outer surface 104 includes a plurality of holes 108 for mounting the housing on the missile body 22 using suitable fasteners. The housing includes an interface 109 for operatively connecting the apparatus 100 to the missile control system 26 (FIG. 1).

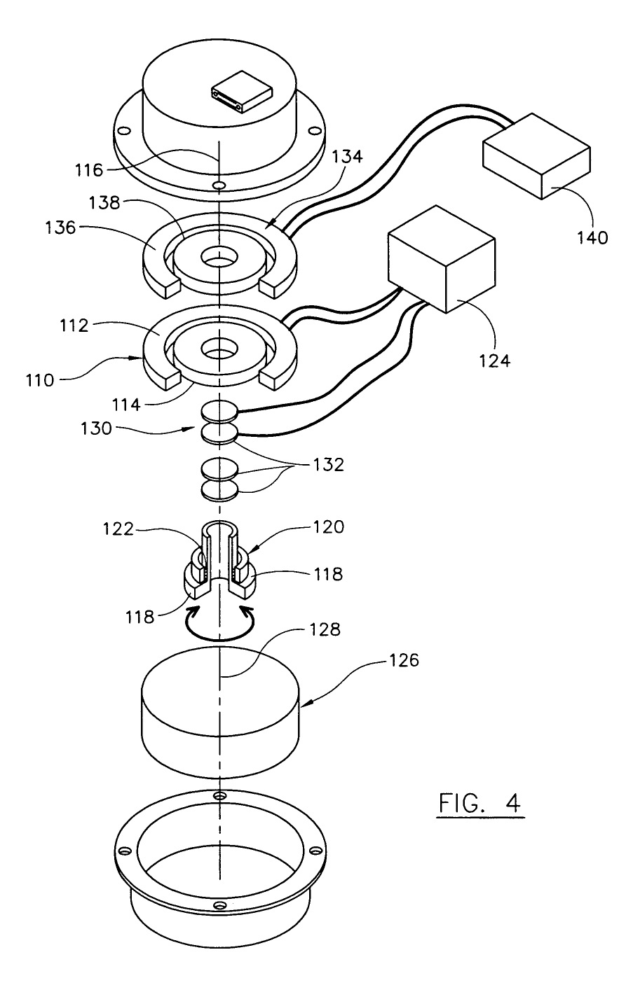

As illustrated in FIGS. 3 and 4, the apparatus 100 includes a motor, generally designated by the reference numeral 110, having a stator 112 rigidly mounted on the mount 102 for movement with the mount and a rotor 114 rotatably mounted on the stator 112 for rotation with respect to the stator about a rotor axis 116. When the mount 102 is mounted on the missile body 22 (FIG. 1), the rotor axis 116 is generally aligned with the axis of rotation 24 (FIG. 1) of the missile body 22. A shaft 118 is coupled to the motor rotor 114 for rotation with the rotor 114 about the rotor axis 116, and is rotatably coupled to the mount 102 for rotation with respect to the mount about the rotor axis 116. In one embodiment, a bearing assembly, generally designated by the reference numeral 120, having a plurality of bearings 122 is mounted between the mount 102 and the shaft 118 to facilitate rotation of the shaft with respect to the mount. As illustrated in FIG. 4, a motor control 124 is operatively connected to the motor 110 for controlling a speed of rotation of the rotor 114, and is configured to rotate the motor rotor 114 about the rotor axis 116 in a direction opposite to the angular velocity of the missile body 22. In one embodiment, the motor control 124 is mounted on the motor 110. In another embodiment, the motor control 124 is mounted on the mount 102 separate from the motor 110. In yet another embodiment, the motor control 124 is mounted on the missile 20 remote from the apparatus 100.

A gyroscope, generally designated by the reference numeral 126, is coupled to the shaft 118 for rotation with the shaft about the rotor axis 116. As further illustrated in FIG. 4, the gyroscope 126 has an input axis 128 generally aligned with the rotor axis 116 and is configured to produce a gyroscope output signal representing an absolute angular velocity at which the gyroscope 126 rotates about the input axis 124. In one embodiment, the gyroscope 126 is selected from a group of gyroscopes consisting of a ring laser gyroscope, an interferometric fiber optic gyroscope, and a hemispherical resonating gyroscope. In one embodiment, the gyroscope 126 is a conventional gyroscope readily available on the commercial market. A slip ring assembly, generally designated by the reference numeral 130, includes a plurality of slip rings 132 operatively connected to the gyroscope 126 and operatively connected to the motor control 124 for transmission of the gyroscope output signal to the motor control 124. The apparatus 100 also includes a resolver, generally designated by the reference numeral 134, having a stationary member 136 mounted on the mount 102 and a rotating member 138 coupled to the shaft 118 for rotation with the shaft about the rotor axis 116. In one embodiment, the resolver 134 is a conventional resolver readily available on the commercial market. A processor 140 is operatively connected to the resolver 134 and is configured to produce a resolver output signal representing a speed of rotation of the rotating member 138 relative to the stationary member 136 about the rotor axis 116.

In operation, the apparatus 100 is mounted on the missile body 22 and operatively connected to the missile control system 26 (FIG. 1). While the missile 20 is in-flight and the missile body 22 is rotating about the axis of rotation 24, the motor control 124 rotates the motor rotor 114 with respect to the missile body about the rotor axis 116, and thereby rotates the gyroscope 126 with respect to the missile body about the input axis 128, in a direction opposite to the angular velocity of the missile body. The motor control 124 rotates the gyroscope 126 about the input axis 128 at a speed such that the absolute angular velocity of the gyroscope about the input axis 128, and thus the gyroscope output signal, tends to remain about zero. As the missile 20 travels along its trajectory or flight path, the motor control 124 continually monitors the gyroscope output signal to selectively control the rotational speed of the motor rotor 114 to maintain the gyroscope output signal at about zero.

As the resolver rotating member 138 rotates about the rotor axis 116 along with the shaft 118, the motor rotor 114, and the gyroscope 126, the resolver 134 measures the rotational speed of the rotating member 138 about the rotor axis 116 to produce the resolver output signal. This rotational speed of the rotating member 138 corresponds to the speed of rotation of the motor rotor 114 about the rotor axis 116 and likewise corresponds to the absolute angular velocity of the missile body 22 about the axis of rotation 24. The processor 140 produces the resolver output signal corresponding to an absolute angular velocity of the missile body 22 about the axis of rotation 24 and transmits the signal to the missile control system 26 via the interface 109. The missile control system 26 uses the resolver output signal to selectively control the absolute angular velocity of the missile body 22 to thereby spin-stabilize the missile body 22.

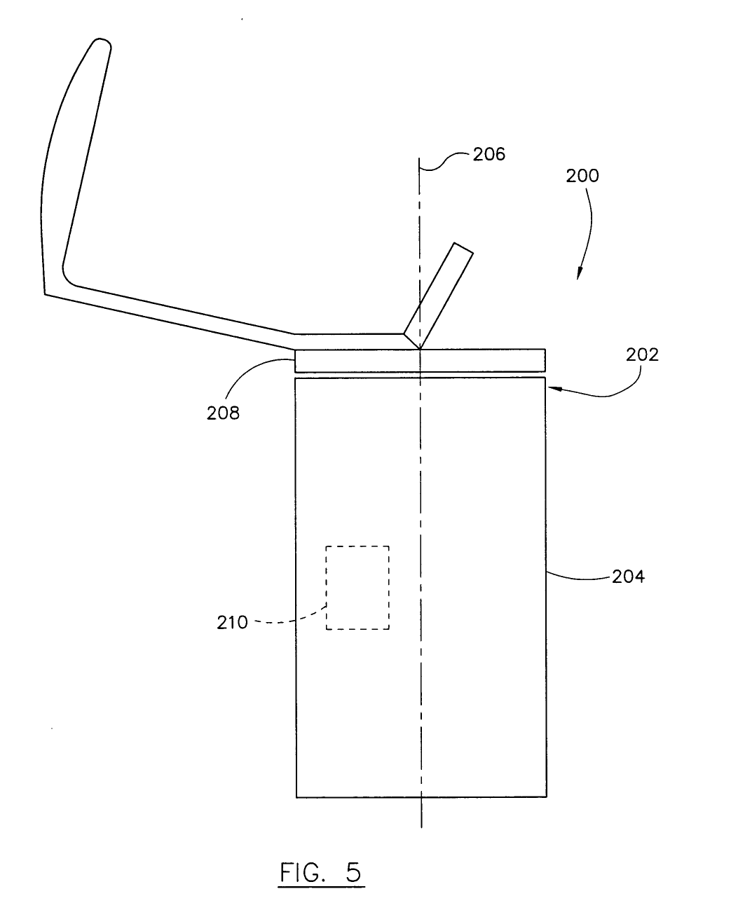

Although the invention is herein described and illustrated in association with a missile, it should be understood that the present invention is generally applicable to determining an absolute angular velocity of any vehicle (i.e., object) that rotates about an axis of rotation. Accordingly, practice of the present invention is not limited to missiles. For example, the present invention is also suitable for determining an absolute angular velocity of a satellite. As illustrated in FIG. 5, an exemplary satellite is generally designated by the reference numeral 200 and includes a body, generally designated by the reference numeral 202, having a drum portion 204 that rotates about an axis of rotation 206 during operation of the satellite and a non-rotating portion 208. The drum portion 204 is generally cylindrical and has an interior cavity (not shown) located therein. A control system 210 is mounted on the drum portion 204 within the interior cavity for generally controlling motion of the satellite 200 using a plurality of thrusters (not shown) mounted on the body 202. Specifically, the control system 210 controls roll, pitch, and azimuth angles of the body 202 as the satellite 200 orbits an external body (not shown), such as the earth, to accurately orientate the body 202 with respect to the external body or an external signal source. The control system 210 also controls rotation of the drum portion 204 about the axis of rotation 206 to spin-stabilize the satellite body 202 as the satellite 200 orbits the external body.

Although the satellite 200 is described and illustrated herein as a conventional dual-spinner or gyrostat satellite, or more specifically a satellite having a rotating drum portion 204 and a non-rotating portion 208, alternatively the satellite 200 may be a conventional spinner satellite wherein the entire satellite rotates about an axis of rotation. It should be understood that the satellite 200 may be any satellite having at least a portion of a body of the satellite that rotates about an axis of rotation.

Similar to the missile 20 (FIG. 1) described above, during operation the apparatus 100 is operatively connected to the satellite control system 210 and is mounted on the drum portion 204. The satellite control system 210 can use the resolver output signal corresponding to an absolute angular velocity of the satellite drum portion 204 about the axis of rotation 206 to selectively control the absolute angular velocity of the drum portion 204 to thereby spin-stabilize the missile body 202.

The above-described apparatus is cost-effective and reliable for determining an absolute angular velocity of a vehicle about an axis of rotation without the use of a gyroscope scale factor. More specifically, the present invention de-spins a gyroscope about its input axis to maintain the gyroscope output at about zero. Accordingly, by measuring the speed of rotation of the gyroscope about its input axis with respect to the vehicle, gyroscope scale factor variations no longer influence measurement of the angular velocity of the vehicle. Additionally, the above-described apparatus uses conventional, commercially available gyroscopes and other components thereby reducing costs.

Exemplary embodiments of apparatus of the present invention are described above in detail. The apparatus is not limited to the specific embodiments described herein, but rather, components of each apparatus may be utilized independently and separately from other components described herein. Each apparatus component can also be used in combination with other apparatus components.

When introducing elements of the present invention or the preferred embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above constructions without departing from the scope of the invention, it is intended that all matter contained in the above description or shown in the accompanying drawings shall be interpreted as illustrative and not in a limiting sense.

1. Apparatus for determining an absolute angular velocity of a vehicle that rotates during operation about an axis of rotation, said apparatus comprising:
a motor having a stator mountable on the vehicle for movement with the vehicle and a rotor rotatably mounted on the stator so the rotor rotates about a rotor axis generally aligned with the axis of rotation of the vehicle;
a gyroscope coupled to the motor rotor so the gyroscope rotates with respect to the stator about the rotor axis, the gyroscope having an input axis generally aligned with the rotor axis, the gyroscope being configured to produce a gyroscope output signal representing an absolute angular velocity at which the gyroscope travels about the input axis;
a motor control operatively connected to the motor for controlling a speed of rotation of the rotor, said control being configured to rotate the gyroscope about the input axis in a direction opposite to the angular velocity of the vehicle so the gyroscope output signal tends to remain about zero; and
a resolver having a stationary member mountable on the vehicle for movement with the vehicle and a rotating member coupled to the motor rotor for rotation with the motor rotor about the rotor axis, the resolver being configured to produce a resolver output signal representing a rotational speed of the rotating member about the rotor axis that corresponds to the speed of rotation of the motor rotor and likewise corresponds to the absolute angular velocity of the vehicle about the axis of rotation.

2. Apparatus in accordance with claim 1 further comprising a mount mountable on the vehicle for movement with the vehicle, the motor stator being coupled to the mount for movement with the mount.

3. Apparatus in accordance with claim 2 wherein the mount comprises a generally cylindrical housing and a flange extending radially outward from an outer surface of the housing for mounting the housing to the vehicle.

4. Apparatus in accordance with claim 1 further comprising a shaft rotatably mounted on the vehicle for rotation with respect to the vehicle about the rotor axis, the shaft being coupled to the motor rotor for rotation with the motor rotor about the rotor axis, the gyroscope being coupled to the shaft for rotation with the shaft about the rotor axis, the resolver rotating member being coupled to the shaft for rotation with the shaft about the rotor axis.

5. Apparatus in accordance with claim 4 further comprising a plurality of slip rings mounted on the shaft, the plurality of slip rings being operatively connected to the gyroscope and the motor control.

6. Apparatus in accordance with claim 4 further comprising a plurality of bearings mounted between the vehicle and the shaft for facilitating rotation of the shaft with respect to the vehicle.

7. Apparatus in accordance with claim 1 wherein the resolver includes a processor for producing the resolver output signal.

8. An apparatus in accordance with claim 1 wherein the gyroscope is selected from a group of gyroscopes consisting of a ring laser gyroscope, an interferometric fiber optic gyroscope, and a hemispherical resonating gyroscope.

9. A vehicle that rotates during operation about an axis of rotation, the vehicle comprising:
a body;
a control system mounted on the body for controlling motion of the vehicle during operation of the vehicle; and
apparatus operatively connected to the control system for determining an absolute angular velocity of the vehicle during operation of the vehicle, the apparatus comprising:
a motor having a stator mounted on the vehicle for movement with the vehicle and a rotor rotatably mounted on the stator so the rotor rotates about a rotor axis generally aligned with the axis of rotation of the vehicle;
a gyroscope coupled to the motor rotor so the gyroscope rotates with respect to the stator about the rotor axis, the gyroscope having an input axis generally aligned with the rotor axis, the gyroscope being configured to produce a gyroscope output signal representing an absolute angular velocity at which the gyroscope travels about the input axis;
a motor control operatively connected to the motor for controlling a speed of rotation of the rotor, said motor control being configured to rotate the gyroscope about the input axis in a direction opposite to the angular velocity of the vehicle so the gyroscope output signal tends to remain about zero; and
a resolver having a stationary member mounted on the vehicle for movement with the vehicle and a rotating member coupled to the motor rotor for rotation with the motor rotor about the rotor axis, the resolver being configured to transmit to the control system a resolver output signal representing a rotational speed of the rotating member about the rotor axis that corresponds to the speed of rotation of the motor rotor and likewise corresponds to the absolute angular velocity of the vehicle about the axis of rotation, the control system being configured to use the resolver output signal to control the absolute angular velocity of the vehicle to thereby spin-stabilize the vehicle.

10. A vehicle in accordance with claim 9 further comprising a mount mounted on the vehicle body for movement with the vehicle, the motor stator being coupled to the mount for movement with the mount.

11. A vehicle in accordance with claim 10 wherein the mount comprises a generally cylindrical housing for the apparatus and a flange extending radially outward from an outer surface of the housing, the flange being mounted to the vehicle body.

12. A vehicle in accordance with claim 11 wherein the housing includes an interface mounted on the outer surface of the housing for operatively connecting the apparatus to the control system.

13. A vehicle in accordance with claim 10 further comprising a shaft rotatably mounted on the mount for rotation with respect to the mount about the rotor axis, the shaft being coupled to the motor rotor for rotation with the motor rotor about the rotor axis, the gyroscope being coupled to the shaft for rotation with the shaft about the rotor axis, the resolver rotating member being coupled to the shaft for rotation with the shaft about the rotor axis.

14. A vehicle in accordance with claim 13 further comprising a plurality of slip rings mounted on the shaft, the plurality of slip rings being operatively connected to the gyroscope and to the motor control.

15. A vehicle in accordance with claim 13 further comprising a plurality of bearings mounted between the mount and the shaft for facilitating rotation of the shaft with respect to the mount.

16. A vehicle in accordance with claim 9 wherein the resolver includes a processor for producing the resolver output signal.

17. A vehicle in accordance with claim 9 wherein the gyroscope is selected from a group of gyroscopes consisting of a ring laser gyroscope, an interferometric fiber optic gyroscope, and a hemispherical resonating gyroscope.

18. A vehicle in accordance with claim 9 wherein the vehicle comprises a missile.

19. A vehicle in accordance with claim 9 wherein the vehicle comprises a satellite.

20. A method for determining an absolute angular velocity of a vehicle that rotates during operation about an axis of rotation, the vehicle including a vehicle body and a gyroscope having an input axis, said method comprising the steps of:
rotatably mounting the gyroscope on the body for rotation with respect to the body so the input axis is generally aligned with the axis of rotation:
rotating the gyroscope with respect to the vehicle body about the input axis in a direction opposite to rotation of the vehicle so an absolute angular velocity of the gyroscope about the input axis tends to remain about zero; and
measuring a rotational speed of the gyroscope about the input axis with respect to the vehicle body, said rotational speed corresponding to the absolute angular velocity of the vehicle about the axis of rotation.
